(19) United States
(12) Patent Application Publication
(10) Pub. No.: US 2022/0102771 A1
(43) Pub. Date: Mar. 31, 2022

(54) BATTERY

(71) Applicant: TOYOTA JIDOSHA KABUSHIKI KAISHA, Toyota-shi (JP)

(72) Inventor: Satomi YAMAMOTO, Miyoshi-shi (JP)

(73) Assignee: TOYOTA JIDOSHA KABUSHIKI KAISHA, Toyota-shi (JP)

(21) Appl. No.: 17/479,288

(22) Filed: Sep. 20, 2021

(30) Foreign Application Priority Data
Sep. 30, 2020 (JP) 2020-166080

(51) Int. Cl. H01M 10/48; H01M 50/538

(52) U.S. Cl. CPC H01M 10/486; H01M 2220/20; H01M 50/538

(57) ABSTRACT

A main object of the present disclosure is to provide a battery capable of accurately detecting the temperature of an electrode body. The present disclosure achieves the object by providing a battery comprising an electrode body, and an exterior body including an inner region configured to house the electrode body, and the battery includes a temperature detector placed so as to extend from the inner region to an outer region of the exterior body, the temperature detector includes a detector portion placed in the inner region and configured to detect a temperature of the electrode body, and a signal wire connected to the detecting portion, the electrode body includes an insulating protective layer on a side thereof, and the detector portion is placed on a surface of the insulating protective layer.

### TECHNICAL FIELD

The present disclosure relates to a battery.

### BACKGROUND ART

A battery including an electrode body (a laminate of a cathode layer, a separator layer, and an anode layer), and further provided with a temperature detector, has been known. For example, Patent Literature 1 discloses a battery comprising a laminate film including an inner resin film, wherein a sensing portion of a temperature sensing element is held between superimposed inner resin films.

### CITATION LIST

### Patent Literature

Patent Literature 1: Japanese Patent No. 4810990

Summary of Disclosure Technical Problem

In Patent Literature 1, a sensing portion of a temperature sensing element is held between superimposed inner resin films. However, there is room for further improving the sensing (detecting) accuracy.

The present disclosure has been made in view of the above circumstances, and a main object thereof is to provide a battery capable of accurately detecting the temperature of an electrode body.

### Solution to Problem

The present disclosure provides a battery comprising an electrode body, and an exterior body including an inner region configured to house the electrode body, and the battery includes a temperature detector placed so as to extend from the inner region to an outer region of the exterior body, the temperature detector includes a detector portion placed in the inner region and configured to detect a temperature of the electrode body, and a signal wire connected to the detector portion, the electrode body includes an insulating protective layer on a side thereof, and the detector portion is placed on a surface of the insulating protective layer.

According to the present disclosure, since the temperature detector includes a detector portion placed on a surface of the insulating protective layer, the temperature of the electrode body may be directly measured. Therefore, the temperature of the electrode body may be detected accurately.

In the disclosure, the detector portion may be covered with a coating layer.

In the disclosure, the temperature detector may include a plurality of the detector portions.

In the disclosure, the battery may include at least a first electrode body and a second electrode body as a plurality of the electrode bodies, the first electrode body may include an electrode tab P, the second electrode body may include an electrode tab R having an opposite polarity to the electrode tab P, the electrode tab P and the electrode tab R may be connected in the inner region.

In the disclosure, the first electrode body and the second electrode body may be stacked along a thickness direction via an insulating member, and the first electrode body and the second electrode body respectively may include: an anode current collector, a first anode layer, a first separator layer, a first cathode layer, and a first cathode current collector, placed in this order from one surface of the anode current collector, and a second anode layer, a second separator layer, a second cathode layer, and a second cathode current collector, placed in this order from another surface of the anode current collector.

Advantageous Effects of Disclosure

The battery in the present disclosure exhibits an effect that the temperature of the electrode body may be detected accurately.

### BRIEF DESCRIPTION OF DRAWING

FIG. 1 is a schematic plan view illustrating an example of a battery in the present disclosure.

FIGS. 2A and 2B are schematic perspective views illustrating an example of a battery and structural members thereof in the present disclosure.

FIG. 3 is a schematic plan view illustrating an example of a temperature detector in the present disclosure.

FIG. 4 is a schematic cross-sectional view illustrating an example of a detector portion in the present disclosure.

FIG. 5 is a schematic cross-sectional view illustrating an example of a detector portion in the present disclosure.

FIGS. 6A to 6C are schematic plan views illustrating an example of a detector portion in the present disclosure.

FIG. 7 is a schematic cross-sectional view illustrating an example of a detector portion in the present disclosure.

FIGS. 8A and 8B are a schematic plan view and a schematic cross-sectional view illustrating an example of an electrode body in the present disclosure.

FIG. 9 is a schematic cross-sectional view illustrating an example of an electrode body in the present disclosure.

FIG. 10 is a schematic cross-sectional view illustrating an example of an electrode body in the present disclosure.

### DESCRIPTION OF EMBODIMENTS

A battery in the present disclosure will be hereinafter described in detail referring to the drawings. Each figure shown below is schematically expressed, and the size and the shape of each member are appropriately exaggerated, to facilitate understanding. Also, in each figure, the hatching indicating the cross-section of a member is appropriately omitted. Also, in the present specification, in expressing an embodiment of arranging a member on another member, when merely expressed as “on” or “under”, it includes both the case of arranging a member directly on or directly under another member so as to be in contact with another member, and the case of arranging a member above or below another member via still another member, unless otherwise specified.

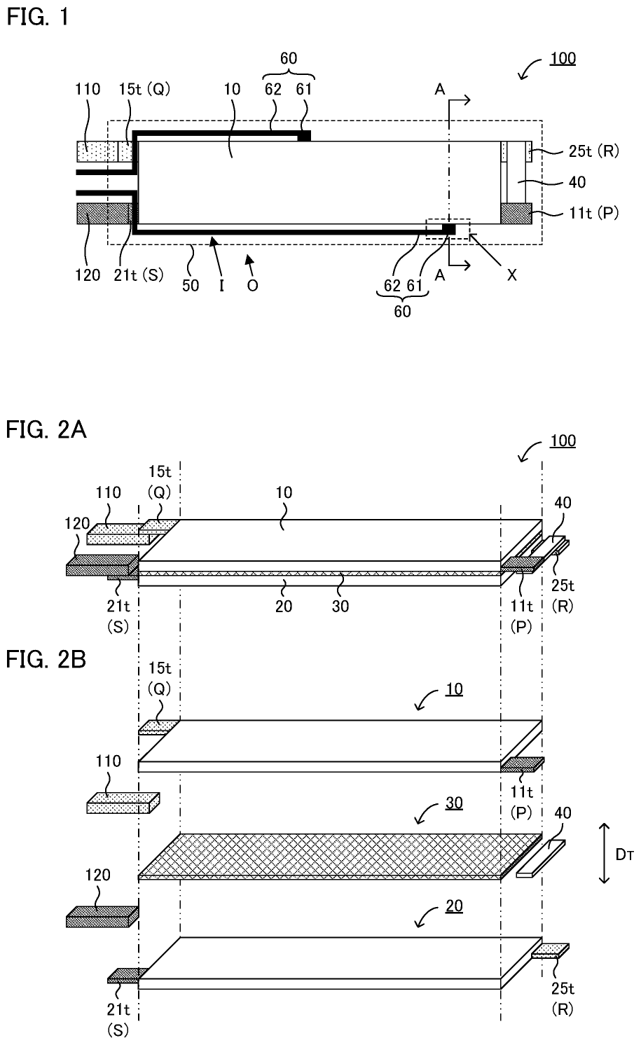

FIG. 1 is a schematic plan view illustrating an example of a battery in the present disclosure. FIGS. 2A and 2B are schematic perspective views illustrating an example of a battery and structural members thereof in the present disclosure. Specifically, FIG. 2A is a schematic perspective view of the battery shown in FIG. 1, and FIG. 2B is a perspective view of the structural members of the battery shown in FIG. 2A. Incidentally, as a matter of convenience, description of the temperature detector is emitted in FIGS. 2A and 2B.

As shown in FIG. 1 and FIGS. 2A and 2B, battery 100 comprises a plurality of electrode bodies (first electrode body 10 and second electrode body 20), and exterior body 50 including inner region I configured to house these. First exterior body 10 includes anode tab 11t (electrode tab P), and cathode tab 15t (electrode tab Q). Meanwhile, second exterior body 20 includes cathode tab 25t (electrode tab R), and anode tab 21t (electrode tab S). Electrode tab P and electrode tab R are connected in inner region I by connecting member 40. Also, as shown in FIG. 1 and FIGS. 2A and 2B, one end of cathode terminal 110 is connected to cathode tab 15t (electrode tab Q) in inner region I, and another end of cathode terminal 110 is placed in outer region O. Similarly, one end of anode terminal 120 is connected to anode tab 21t (electrode tab S) in inner region I, and another end of anode terminal 120 is placed in outer region O.

Also, as shown in FIG. 1, battery 100 comprises temperature detector 60 placed so as to extend from inner region I to outer region O of exterior body 50. Temperature detector 60 includes detector portion 61 which is placed in inner region I and is configured to detect the temperature of the electrode body (first electrode body 10, second electrode body 20), and signal wire 62 connected to detector portion 61. Signal wire 62 extends from inner region I to outer region O, and includes outer terminal portion (not shown in the figure) configured to connect to a control substrate, at the end thereof. In FIG. 1, signal wire 62 is placed along the longitudinal direction of the electrode body.

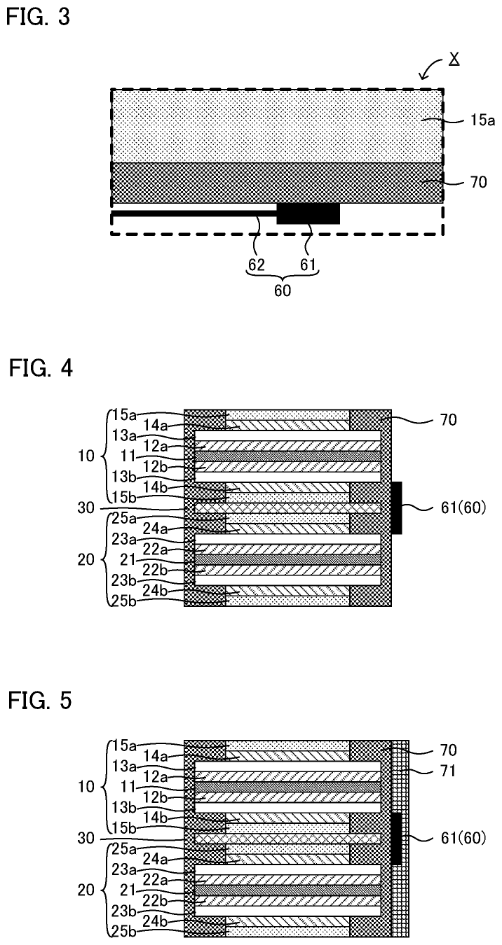

FIG. 3 is a schematic plan view illustrating an example of a temperature detector in the present disclosure, and corresponds to an enlarged view of region X in FIG. 1. Also, FIG. 4 corresponds to a cross-sectional view taken along the line A-A in FIG. 1. As shown in FIG. 3 and FIG. 4, the electrode body (first electrode body 10, second electrode body 20) includes an insulating protective layer 70 on the side thereof. Further, detector portion 61 of temperature detector 60 is placed on the surface of insulating protective layer 70. Respect to the electrode body (first electrode body 10, second electrode body 20), insulating protective layer 70 and detector portion 61 are placed on the side surface of the electrode body (first electrode body 10, second electrode body 20).

According to the present disclosure, since the temperature detector includes the detector portion placed on the surface of the insulating protective layer, the temperature of the electrode body may be directly measured. Therefore, the temperature of the electrode body may be accurately detected. For example, when the temperature of the electrode body may not be accurately detected, the usable temperature range of the battery should be set considering a large error. Meanwhile, when the temperature of the electrode body may be detected with high accuracy, there is no need to consider a large error, so that the usable temperature range of the battery may be substantially widened.

Also, for example, a case wherein the temperature detector is placed directly on the side surface of the electrode body, is assumed. In this case, it is difficult to stably fix the temperature detector unless the side surfaces of the respective members constituting the electrode body are flush. For example, in order to suppress the short circuit, there may be a case wherein the area of the anode layer is designed to be larger than the area of the cathode layer. For example, in FIG. 4, the area of first anode layer 12a is larger than the area of first cathode layer 14a so that the end portion of first anode layer 12a is protruded from the end portion of first cathode layer 14a. Therefore, the side surface of first anode layer 12a and the side surface of first cathode layer 14a are not flush with each other. In such a case, it is difficult to stably fix the temperature detector when the temperature detector is directly placed on the side surface of the first electrode body. Meanwhile, in the present disclosure, since the temperature detector is placed on the surface (preferably a flat surface) of the insulating protective layer protecting the side surface of the electrode body, the temperature detector may be stably fixed.

Also, for example, a case wherein the temperature detector is placed on a plane (main surface) of the electrode body, is assumed. In this case, since the area of the detector portion is usually smaller than the area of the electrode, a step difference may occur, which may cause cracking of the electrode or non-uniform battery reaction. In particular, in an all solid state battery to which a strong confining pressure is applied in the thickness direction, the possibility of a failure is higher. Meanwhile, in the present disclosure, by placing the temperature detector not on the plane (main surface) of the electrode body but on the side surface, it is possible to suppress the occurrence of the above-described failure.

1. Structure of Battery

As shown in FIG. 1, the battery in the present disclosure comprises temperature detector 60 placed so as to extend from inner region I to outer region O of exterior body 50. Further, temperature detector 60 is placed in inner region I, and includes detector portion 61 configured to detect the temperature of the electrode body (first electrode body 10, second electrode body 20), and signal wire 62 connected to detector portion 61. Examples of detector portion 61 may include temperature sensors such as a thermistor and a thermocouple.

As shown in FIG. 4, the electrode body (first electrode body 10, second electrode body 20) includes insulating protective layer 70 on the side surface. By providing insulating protective layer 70 on the side thereof, the short circuit may be suppressed, or it is possible to suppress the positional deviation of each member constituting the electrode body. Examples of the material of the insulating protective layer may include a resin, and specific examples of the resin may include a urethane acrylate resin, an epoxy resin, and an olefin resin. Also, the resin may be a thermoplastic resin, and may be a cured resin (such as a cured product of a thermosetting resin or an ultraviolet curable resin). Also, detector portion 61 is placed on the surface of insulating protective layer 70. Detector portion 61 may be fixed by, for example, an adhesive.

Also, as shown in FIG. 5, the electrode body (first electrode body 10, second electrode body 20) may include insulating protective layer 70 on the side thereof, and detector portion 61 may be placed on the surface of insulating protective layer 70, and further, may be covered with coating layer 71. By covering detector portion 61 with coating layer 71, mechanical loads applied to detector portion 61 (such as vibration and impact) may be reduced advantageously. Also, by covering detector portion 61 with coating layer 71, there is an advantage that a damage to the exterior body by detector portion 61 may be suppressed. Coating layer 71 may cover at least a part of the surface of detector portion 61 facing away from insulating protective layer 70, and may cover the entire surface. Examples of the material of the coating layer may include the same materials as those of insulating protective layer described above. The structure shown in FIG. 5 is obtained, for example, by placing detector portion 61 on the surface of insulating protective layer 70, and then, forming coating layer 71 that coats detector portion 61 using the same or different resin as the resin used for insulating protective layer 70.

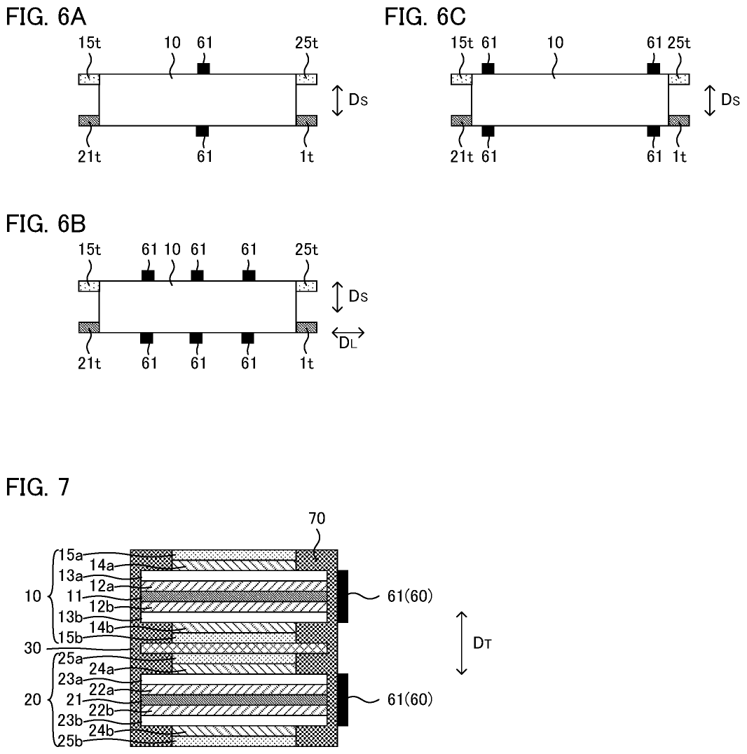

The temperature detector in the present disclosure may include only one detector portion, or may include a plurality of detector portions. By providing a plurality of detector portions, it is possible to detect the temperature unevenness in the electrode body. By controlling the electrode body in accordance with the detected temperature unevenness, the temperature of the electrode body may be made even, and, for example, the cycle property may be improved. FIGS. 6A to 6C are schematic plan views illustrating an example of a detector portion in the present disclosure. In FIGS. 6A to 6C, for convenience, the description of the signal wire of the temperature detector is omitted. As shown in FIG. 6A, detector portions 61 may be placed respectively on different sides opposing to each other, in the short-side direction D_{S}. Also, as shown in FIG. 6B, detector portions 61 may be placed respectively on different sides opposing to each other, in the short-side direction D_{S}, and further, a plurality of detector portions 61 may be placed along the long-side direction DL. Also, the interval of the plurality of detector portions 61 placed along the long-side direction DL may be equally spaced. Also, as shown in FIG. 6C, detector portion 61 may be placed in the vicinity of the electrode tab (at least one of anode tab 11t, cathode tab 15t, anode tab 21t, and cathode tab 25t). Since the temperature is likely to be high in the vicinity of the electrode tab, by placing the detector portion therein, for example, it is possible to accurately detect the temperature abnormality. The vicinity of the electrode tab means a range wherein the shortest distance between the electrode tab and the detector portion is 5 cm or less.

Incidentally, in FIG. 6A, detector portions 61 are placed respectively on different sides opposing to each other, in the short-side direction D_{S}. However, it is not necessary to place two detector portions 61 on different sides opposing to each other, in the short-side direction D_{S}. For example, the region wherein the temperature is the highest (such as the vicinity of the electrode tab) and the region wherein the temperature is the lowest during battery operation may be determined by carrying out preliminary experiments or simulations in advance, and the detector portions may be placed at least at the two locations. Also, in FIG. 6A to 6C, a plurality of detector portions 61 are placed on different sides opposing to each other, in the short-side direction D_{S}. However, in the present disclosure, a single detector portion 61 or a plurality of detector portions 61 may be placed on different sides opposing to each other (a portion other than the tab), in the long-side direction DL.

Also, as shown in FIG. 7, a plurality of detector portions 61 of temperature detector 60 may be placed on the surface of insulating protective layer 70 along the thickness direction DT of the electrode body (first electrode body 10, second electrode body 20). As shown in FIG. 7, two detector portions 61 may be placed so as to correspond to first electrode body 10 and second electrode body 20. Meanwhile, although not shown in the figures a plurality of detector portions may be placed at the locations wherein temperature unevenness is likely to occur; on the battery surface side (such as at least one of the vicinity of first cathode current collector 15a and the vicinity of second cathode current collector 25b in FIG. 7), and at the battery central side (such as in the vicinity of insulating member 30 in FIG. 7).

The battery in the present disclosure comprises an electrode body, and an exterior body including an inner region configured to house the electrode body. Also, the battery in the present disclosure may include only one electrode body, and may include a plurality of electrode bodies.

For example, as shown in FIG. 1 and FIGS. 2A and 2B, as the electrode body, battery 100 may include first electrode body 10 and second electrode body 20. The first electrode body includes electrode tab P, and electrode tab Q having the opposite polarity to the electrode tab P. In FIG. 1, for example, electrode tab P is an anode tab, and electrode tab Q is a cathode tab. Meanwhile, the second electrode body includes electrode tab R having the opposite polarity to the electrode tab P, and electrode tab S having the opposite polarity to the electrode tab R. In FIG. 1, for example, electrode tab R is a cathode tab, and electrode tab S is an anode tab. Also, although not shown in the figures, when electrode tab P is a cathode tab, electrode tab Q is an anode tab, electrode tab R is an anode tab, and electrode tab S is a cathode tab.

As shown in FIG. 1, electrode tab P and electrode tab R may be connected in inner region I. “Connection” in the present disclosure means at least an electrical connection, and may or may not mean a physical connection (direct contact), within the range not technically contradicting. As shown in FIG. 1 and FIGS. 2A and 2B, electrode tab P and electrode tab R are placed on the identical side of the electrode body, and respectively in contact with connecting member 40. Thereby, first electrode body 10 and second electrode body 20 are connected in series. Meanwhile, although not shown in the figures, electrode tab P and electrode tab R may be directly connected, not via the connecting member.

Also, as shown in FIGS. 2A and 2B, first electrode body 10 and second electrode body 20 may be stacked along the thickness direction DT via insulating member 30. Here, the following case is assumed: a first current collector placed on the most second electrode body 20 side in first electrode body 10, and a second current collector placed on the most first electrode body 10 side in second electrode body 20 have opposite polarities. For example, the following case is assumed: the first current collector is a cathode current collector, and the second current collector is an anode current collector. In this case, in order to connect first electrode body 10 and second electrode body 20 in series, the first current collector and the second current collector may be simply contacted with each other, and the need to provide insulating member 30 is low.

Meanwhile, a case wherein the first current collector and the second current collector have the same polarity is assumed. In this case, in order to connect first electrode body 10 and second electrode body 20 in series, it is preferable to place insulating member 30 between first electrode body 10 and second electrode body 20 and connect electrode tab P and electrode tab R, as shown in FIGS. 2A and 2B. In particular, when both the first electrode body and the second electrode body have a structure as shown in FIG. 9, that is, a structure including current collector having the same polarity on both sides, it is preferable to place the insulating member between the first electrode body and the second electrode body since the opposing first current collector and second current collector have the same polarity.

FIG. 4 is a schematic cross-sectional view illustrating an example of a battery in the present disclosure, and corresponds to the cross-sectional view taken along the line A-A in FIG. 1. In FIG. 4, first electrode body 10 includes anode current collector 11; first anode layer 12a, first separator layer 13a, first cathode layer 14a, and first cathode current collector 15a placed in this order from one surface of anode current collector 11; and second anode layer 12b, second separator layer 13b, second cathode layer 14b, and second cathode current collector 15b placed in this order from another surface of anode current collector 11. Meanwhile, second electrode body 20 includes anode current collector 21; first anode layer 22a, first separator layer 23a, first cathode layer 24a, and first cathode current collector 25a placed in this order from one surface of anode current collector 21; and second anode layer 22b, second separator layer 23b, second cathode layer 24b, and second cathode current collector 25b placed in this order from another surface of anode current collector 21. Also, insulating member 30 is placed between second cathode current collector 15b in first electrode body 10 and first cathode current collector 25a in second electrode body 20.

Examples of the material of the insulating member may include a resin, and specific examples of the resin include polyolefin resins such as polypropylene (PP) and polyethylene (PE); a polyimide resin; and a polyphenylene sulfide resin (PPS). The insulating member is preferably larger than the first current collector (current collector placed on the most second electrode body 20 side in first electrode body 10) and the second current collector (current collector placed on the most first electrode body 10 side in second electrode body 20) in plan view. That is, it is preferable that the insulating member includes the first current collector and the second current collector in plan view. The reason therefor is to effectively insulate the first current collector and second current collector. Further, it is preferable that the insulating member is larger than the largest current collector in the first electrode body (for example, anode current collector 11 in FIG. 4) and the largest current collector in the second electrode body (for example, anode current collector 21 in FIG. 4) in plan view. This is because, for example, the short circuit is less likely to occur, when the battery is pressurized (confined) from the outside.

Also, as shown in FIG. 1, cathode terminal 110 and anode terminal 120 may be placed on the identical side of the electrode body. In such case, the battery structure may be simplified, and the volume energy density may be easily improved. Also, when cathode terminal 110 and anode terminal 120 are placed on the identical side of the electrode body, it is preferable that cathode terminal 110 and anode terminal 120 are placed so as not to overlap with each other in plan view. The reason therefor is to suppress the short circuit. Also, the derivation portion (a portion wherein temperature detector 60 is derived from inside exterior body 50 to outside thereof) of temperature detector 60 may also be placed on the identical side. In this case, the volume energy density may further be improved. Also, the derivation portion of the temperature detector may not be placed on the identical side. The cathode terminal and the anode terminal may be placed on different sides opposing to each other, of the electrode body.

When the number of electrode bodies included in the battery in the present disclosure is regarded as “N”, the number of “N” may be 1, may be 2, and may be 3 or more. Meanwhile, the number of “N” is, for example, 100 or less. When the battery in the present disclosure includes the first electrode body to the N-th electrode body (2≤N), the electrode tab T_{N-1} in the (N−1)th electrode body and the electrode tab T_{N} in the Nth electrode body may be connected to each other in the inner region of the exterior body. Incidentally, the electrode tab T_{N-1} and the electrode tab T_{N} have the opposite polarity to each other. Also, the first electrode body to the Nth electrode body are preferably same member. Also, the battery in the present disclosure may include a plurality of insulating members, and the insulating members may be placed between adjacent electrode bodies, respectively.

2. Configuration of Electrode Body

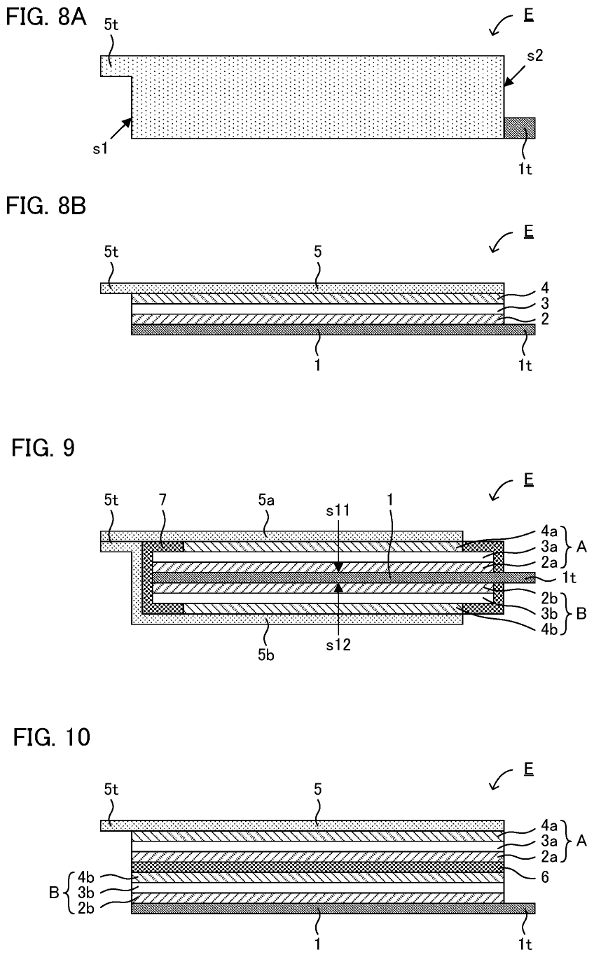

FIG. 8A is a schematic plan view illustrating an example of electrode body in the present disclosure, and FIG. 8B is a side view of FIG. 8A. Electrode body E shown in FIGS. 8A and 8B includes: cathode layer 4; anode layer 2; separator layer 3 placed between cathode layer 4 and anode layer 2; cathode current collector 5 configured to collect current of cathode layer 4; and anode current collector 1 configured to collect current of anode layer 2. Cathode current collector 5 includes cathode tab 5t at a position that does not overlap with cathode layer 4, in planar view. Similarly, anode current collector 1 includes anode tab 5t at a position that does not overlap with anode layer 2, in planar view. Cathode current collector 5 and cathode tab 5t may be one member, and may be different members, as long as they are electrically connected to each other. This also applies to anode current collector 1 and anode tab 1t.

Also, in planar view, as shown in FIG. 8A, cathode tab 5t and anode tab 1t may be respectively placed at the different sides (side s1, side s2) opposing to each other (both-side tab structure). Meanwhile, although not shown in the figures, the cathode tab and the anode tab may be placed on the identical side respectively (one-side tab structure). Also the plan-view shape of the electrode body (plan-view shape excluding cathode tab and anode tab) is, for example, a rectangular shape. As shown in FIG. 8A, the plan-view shape of electrode body E excluding cathode tab 5t and anode tab 1t is a rectangular shape. Cathode tab 5t and anode tab 1t are place to oppose to each other in the longitudinal direction of electrode body E.

The electrode body in the present disclosure may include one power generation element including a cathode layer, a separator layer, and an anode layer, may include two of them, and may include three or more of them. When the electrode body includes a plurality of power generation elements, they may be connected in parallel and may be connected in series.

FIG. 9 is a schematic cross-sectional view illustrating an example of an electrode body in the present disclosure, and is a schematic cross-sectional view illustrating a condition wherein a plurality of power generation elements are connected in parallel. Electrode body E shown in FIG. 9 includes: anode current collector 1; first anode layer 2a, first separator layer 3a, first cathode layer 4a, and first cathode current collector 5a placed in this order from one surface s11 of anode current collector 1; and second anode layer 2b, second separator layer 3b, second cathode layer 4b, and second cathode current collector 5b placed in this order from another surface s12 of anode current collector 1. First cathode current collector 5a and second cathode current collector 5b are connected to each other, and constitute cathode tab 5t. Also, insulating protective layer 7 is placed between second cathode current collector 5b and side surface of anode (anode current collector 1, first anode layer 2a, and second anode layer 2b) in order to prevent a short circuit.

Electrode body E shown in FIG. 9 is useful as, for example, an electrode body used in an all solid state battery including an inorganic solid electrolyte such as oxide solid electrolyte, and sulfide solid electrolyte. In an all solid state battery including an inorganic solid electrolyte, the electrode body must be pressed at very high pressures in order to form good ion conducting paths. In this case, since the configuration of the other layers is symmetrical with respect to anode current collector 1, electrode E shown in FIG. 9 is advantageous in that a stress due to the difference in the stretching ability of the cathode layer and the anode layer is not likely to be generated. Specifically, in electrode body E shown in FIG. 9, first anode layer 2a, first separator layer 3a, first cathode layer 4a, and first cathode current collector 5a are placed in this order on one surface s11 with respect to anode current collector 1, and second anode layer 2b, second separator layer 3b, second cathode layer 4b, and second cathode current collector 5b are placed in this order on another surface s12. Since the configuration of the other layers is symmetrical with respect to anode current collector 1 as described above, a stress due to the difference in the stretching ability of the cathode layer and the anode layer is not likely to be generated. As the result, the breakage of the anode current collector and cracking of the cathode layer and the anode layer may be suppressed. Also, in the present disclosure, a plurality of electrode bodies E shown in FIG. 9 may be used, and these may be stacked in the thickness direction to form one electrode body E′. At this time, the opposing cathode current collector (first cathode current collector 5a in one electrode body E and second cathode current collector 5b in another electrode body E) may be different member with each other, and may be one member (one cathode current collector may be shared).

Also, electrode body E shown in FIG. 9 includes two cathode current collectors per one anode current collector. Meanwhile, the electrode body in the present disclosure may include two anode current collectors per one cathode current collector. That is, the electrode body in the present disclosure may include a cathode current collector; a first cathode layer, a first separator layer, a first anode layer and a first anode current collector, placed in this order from one surface of the cathode current collector; and a second cathode layer, a second separator layer, a second anode layer and a second anode current collector, placed in this order from another surface of the cathode current collector. In this case, the first anode current collector and the second anode current collector may be connected to constitute an anode tab.

FIG. 10 is a schematic cross-sectional view illustrating an electrode body in the present disclosure, and is a schematic cross-sectional view illustrating a condition wherein a plurality of power generation elements are connected in series. Electrode body E shown in FIG. 10 includes power generation element A including first cathode layer 4a, first separator layer 3a, and first anode layer 2a, and power generation element B including second cathode layer 4b, second separator layer 3b, and second anode layer 2b. First cathode layer 4a in power generation element A is connected to cathode current collector 5, and second anode layer 2b in power generation element B is connected to anode current collector 1. Also, first anode layer 2a in power generation element A and second cathode layer 4b in power generation element B are electrically connected via intermediate current collector 6.

The cathode layer includes at least a cathode active material. Further, the cathode layer may include at least one of a conductive material, an electrolyte, and a binder. Examples of the cathode active material may include an oxide active material. Examples of the oxide active material may include rock salt bed type active materials such as LiNi_{1/3}Co_{1/3}Mn_{1/3}O₂; spinel type active materials such as LiMn₂O₄; and olivine type active materials such as LiFePO₄. Also, sulfur (S) may be used as the cathode active material. Examples of the shape of the cathode active material may include a granular shape. Examples of the conductive material may include a carbon material. The electrolyte may be a liquid electrolyte, and may be a solid electrolyte. The liquid electrolyte (electrolyte solution) includes, for example, supporting salts such as LiPF₆ and a solvent such as a carbonate-based solvent. The solid electrolyte may be an organic solid electrolyte such as a gel electrolyte, and may be an inorganic solid electrolyte such as an oxide solid electrolyte and a sulfide solid electrolyte. Also, examples of the binder may include a rubber-based binder and a fluoride-based binder.

The anode layer includes at least an anode active material. Further, the anode layer may include at least one of a conductive material, an electrolyte, and a binder. Examples of the anode active material may include a metallic active material such as Li and Si; a carbon active material such as graphite; and an oxide active material such as Li₄Ti₅O₁₂. Examples of the shape of the anode active material may include a granular shape and foil shape. The conductive material, the electrolyte, and the binder are the same as those described above. The separator layer includes at least an electrolyte. The electrolyte may be a liquid electrolyte and may be a solid electrolyte. Also, examples of the material of the cathode current collector may include aluminum, SUS, nickel, and carbon. Examples of the material of the anode current collector may include copper, SUS, nickel, and carbon. The shapes of the cathode current collector and the anode current collector are, for example, a foil shape.

3. Battery

Battery in the present disclosure includes an exterior body including an inner region configured to house the electrode body. The exterior body may or may not have flexibility. Examples of the former may include an aluminum laminate film, and examples of the latter may include a case made of SUS. Also, when the exterior body is a laminated film, a sealing region wherein the inner resin layers of the laminated film are melted, may be included between the inner region and the outer region of the exterior body.

The kind of the battery in the present disclosure is not particularly limited; and is typically a lithium ion secondary battery. Further, the use of battery in the present disclosure is not particularly limited, and examples thereof may include a power supply of a vehicle such as a hybrid electric vehicle, a battery electric vehicle, a gasoline-powered vehicle, and a diesel-powered vehicle. In particular, it is preferably used in the driving power supply of a hybrid electric vehicle, or a battery electric vehicle. Also, the battery in the present disclosure may be used as a power source for moving objects other than vehicles, such as railroad vehicles, ships, and airplanes, or may be used as a power source for electric appliances such as information processing apparatuses.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### REFERENCE SIGNS LIST

1 . . . anode current collector
1t . . . electrode tab
2 . . . anode layer
3 . . . separator layer
4 . . . cathode layer
5 . . . cathode current collector
5t . . . cathode tab
10 . . . first electrode body
20 . . . second electrode body
30 . . . insulating member
40 . . . connecting member
50 . . . exterior body
60 . . . temperature detector
61 . . . detector portion
62 . . . signal wire
70 . . . insulating protective layer
100 . . . battery

What is claimed is:

1. A battery comprising an electrode body, and an exterior body including an inner region configured to house the electrode body, and
the battery includes a temperature detector placed so as to extend from the inner region to an outer region of the exterior body,
the temperature detector includes a detector portion placed in the inner region and configured to detect a temperature of the electrode body, and a signal wire connected to the detecting portion,
the electrode body includes an insulating protective layer on a side thereof, and
the detector portion is placed on a surface of the insulating protective layer.

2. The battery according to claim 1, wherein the detector portion is covered with a coating layer.

3. The battery according to claim 1, wherein the temperature detector includes a plurality of the detector portions.

4. The battery according to claim 1, wherein the battery includes at least a first electrode body and a second electrode body as a plurality of the electrode bodies,
the first electrode body includes an electrode tab P,
the second electrode body includes an electrode tab R having an opposite polarity to the electrode tab P,
the electrode tab P and the electrode tab R are connected in the inner region.

5. The battery according to claim 4, wherein the first electrode body and the second electrode body are stacked along a thickness direction via an insulating member, and
the first electrode body and the second electrode body respectively include:
an anode current collector,
a first anode layer, a first separator layer, a first cathode layer, and a first cathode current collector, placed in this order from one surface of the anode current collector, and
a second anode layer, a second separator layer, a second cathode layer, and a second cathode current collector, placed in this order from another surface of the anode current collector.
